(19) United States
(12) Patent Application Publication
(10) Pub. No.: US 2015/0065929 A1
(43) Pub. Date: Mar. 5, 2015

(54) GUM MASSAGING MOUTHPIECE

(71) Applicant: EDWARD WALKER, SANFORD, FL (US)

(72) Inventor: EDWARD WALKER, SANFORD, FL (US)

(21) Appl. No.: 14/012,049

(22) Filed: Aug. 28, 2013

(51) Int. Cl. A61H 13/00

(52) U.S. Cl. CPC A61H 13/00
USPC 601/139

(57) ABSTRACT

A gum massaging mouthpiece includes a main body having a generally C-shaped base member that is in communication with an integrally formed inner and outer wall. A plurality of nubs are disposed along the mouthpiece so as to make contact with the gums of a user, and a plurality of electrically controlled vibrating elements provide a vibration force to the nubs for massaging the gums of a user.

### TECHNICAL FIELD

The present invention relates generally to dental appliances, and more particularly to a mouthpiece for massaging gums.

### BACKGROUND

The statements in this section merely provide background information related to the present disclosure and may not constitute prior art.

As any dentist will attest, in order to maintain intraoral health, in addition to brushing with a toothbrush, a gum massage which is an operation of massaging gums to promote blood circulation should be routinely performed so as to prevent pyorrhea and gingivitis.

Although a gum massage may be performed utilizing a conventional hard-bristle toothbrush, such action oftentimes results in damage to the surface of the gums owing to the application of excessive force and the physical contact with the hardened bristles. For this reason, gum massaging tools which typically include an elongated shaft having a soft tip and a vibrating mechanism have been created.

However, owing to the design, size and weight of these conventional tools, users are often unable to reach all areas of their gums, and are also unable to ensure that each portion of their gums receive equal and adequate attention.

Accordingly, these and other such difficulties have been obviated in a novel manner by the gum massaging mouthpiece that is described herein.

### SUMMARY OF THE INVENTION

The present invention is directed to a gum massaging mouthpiece. One embodiment of the present invention can include a main body having a generally C-shaped base member that is in communication with an integrally formed inner and outer wall. The mouthpiece may also include a plurality of nubs that are disposed along the mouthpiece so as to make contact with the gums of a user. A plurality of vibrating elements can also be provided, and can function to provide a vibration to the nubs whereby the gums can receive a massage.

Another embodiment of the present invention can further include a control unit which can function to control an operation of the mouthpiece.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of the gum massaging mouthpiece, in accordance with one embodiment of the invention.

FIG. 2 is another perspective view of the gum massaging mouthpiece showing the plurality of vibrating elements, in accordance with one embodiment of the invention.

FIG. 3 is a back side view of the gum massaging mouthpiece, in accordance with one embodiment of the invention.

FIG. 4 is a simplified block diagram of the control unit of the gum massaging mouthpiece, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

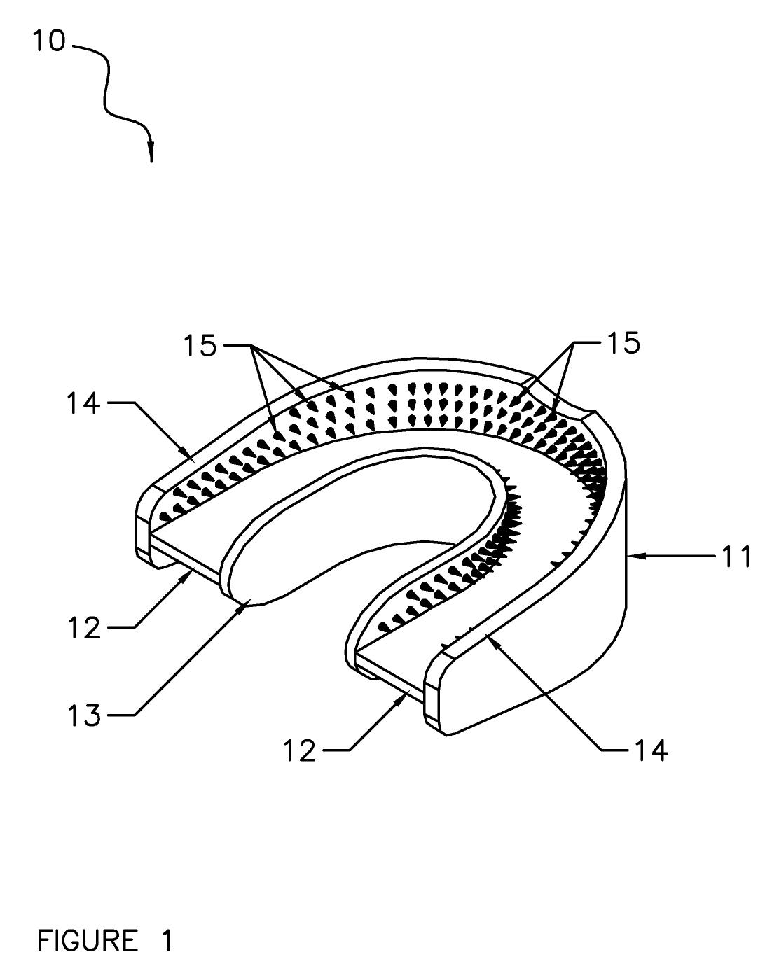

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, one embodiment of a gum massaging mouthpiece 10 includes a main body 11 having a plurality of gum massaging nubs 15 and vibrating elements 25. The vibrating elements being operable by a user via a control unit 40. Although the below described concepts may be particularly applicable to the field of dentistry, the device is not to be construed as limiting for use by professionals such as dentists and/or dental hygienists, as the inventive concepts disclosed herein are fully capable of being utilized by individuals in a home setting.

FIGS. 1-3 illustrate one embodiment of the gum massaging mouthpiece 10 that is useful for understanding the inventive concepts disclosed herein. As shown, the main body 11 can include a generally C-shaped base member 12 from which a generally orthogonal inner wall 13 and outer wall 14 can extend, thereby forming a channel for receiving the teeth and gums of a user.

As described herein, the main body 11 of the device 10 can be constructed in a variety of sizes to fit within the mouths of men, women and children wherein the base 12 is adjacent to the occlusal surface of the users teeth, the inner wall 13 is adjacent to the palatal surface of the users teeth and gums, and the outer wall 14 is positioned adjacent to the buccal surface of the users teeth and gums. Stated differently, it is preferred that the walls 12 and 13 extend beyond the users teeth so as to make contact with the portion of the gums extending from the teeth to the cheek, for example. As such, the front wall 14 can include a different height than the rear wall 13.

In one preferred embodiment, the body 11 can be constructed from at least one thermoplastic material that is resilient and relatively rigid, which is defined as being able to bend when pressure is applied by a user, but cannot be permanently deformed at room or body temperature. In some embodiments, the main body 11 can be constructed so as to become ductile when heat is applied to the device, such as depositing the same into boiling water for a short period of time, for example. In this regard, the body 11 can be permanently deformed when the material returns to room or body temperature. Such a feature can allow a user to customize the fit of the device within their mouth. Of course, any number of other construction materials such as rubber and known manufacturing methodologies are also contemplated.

As shown, one or more of the base member 12, the inner wall 13 and the outer wall 14 can include a plurality of flexible nubs 15 radiating toward the center of the channel formed by the walls 13 and 14. In one preferred embodiment, each of the nubs 15 can include soft resilient and identically sized protrusions having a generally frustoconical shape that are disposed evenly across the entirety of the inner surface of the inner and outer walls.

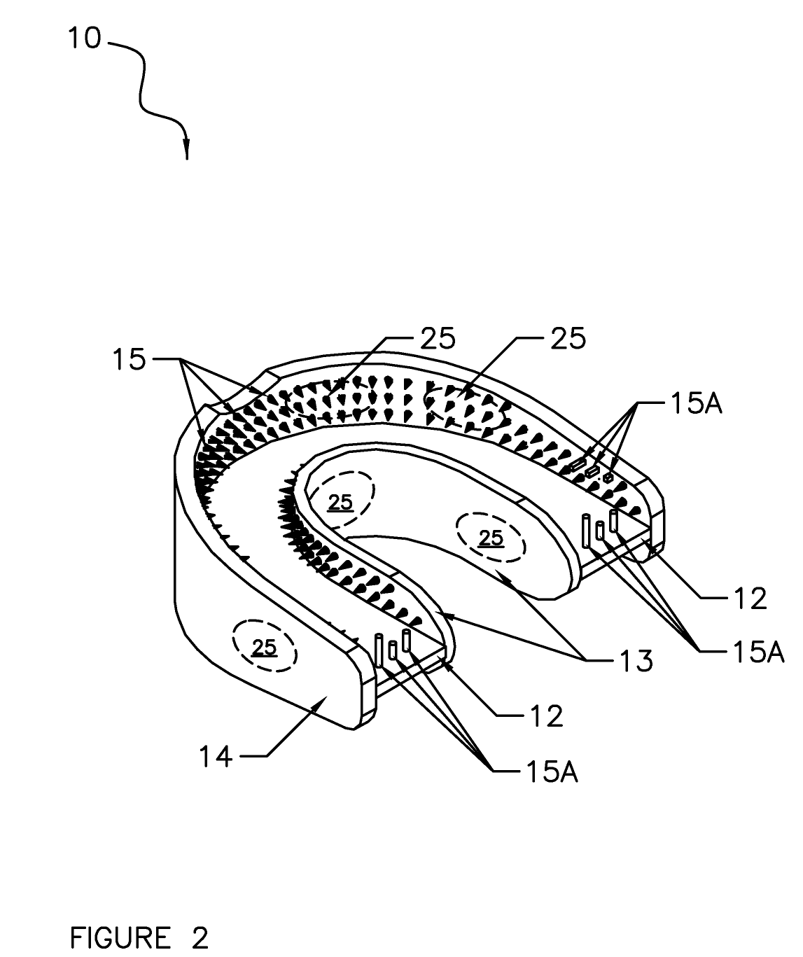

Of course any number of other shapes, sizes and locations are also contemplated as shown by the nubs 15a in FIG. 2. In either instance, the nubs can also preferably be constructed from at least one thermoplastic material that is also resilient and relatively rigid, but that will not become ductile when heat is applied thereto. To this end, the nubs can be formed as a unitary element of the body. However, the nubs can also be constructed from a completely different material than the main body, such as rubber, for example, and can be joined with the main body in accordance with known construction methodologies.

A plurality of vibration elements 25 can be disposed throughout the main body 11, and can function to vibrate the plurality of nubs 15 when the device is inserted into the mouth of a user. As shown, these elements 25 can be located within one or more of the base member 12, the inside wall 13 and the outside wall 14. In the preferred embodiment, each of the vibration elements 25 can include a lightweight generally disc shaped moving coil DC motor that is capable of creating a variable speed vibration utilizing extremely low power. These motors are well known in the art and include, for example, U.S. Patent Publication No. 2002/0047469, to Park, the contents of which is incorporated herein by reference.

Although described above as including a plurality of vibrating elements, other embodiments utilizing a single vibrating element are also contemplated.

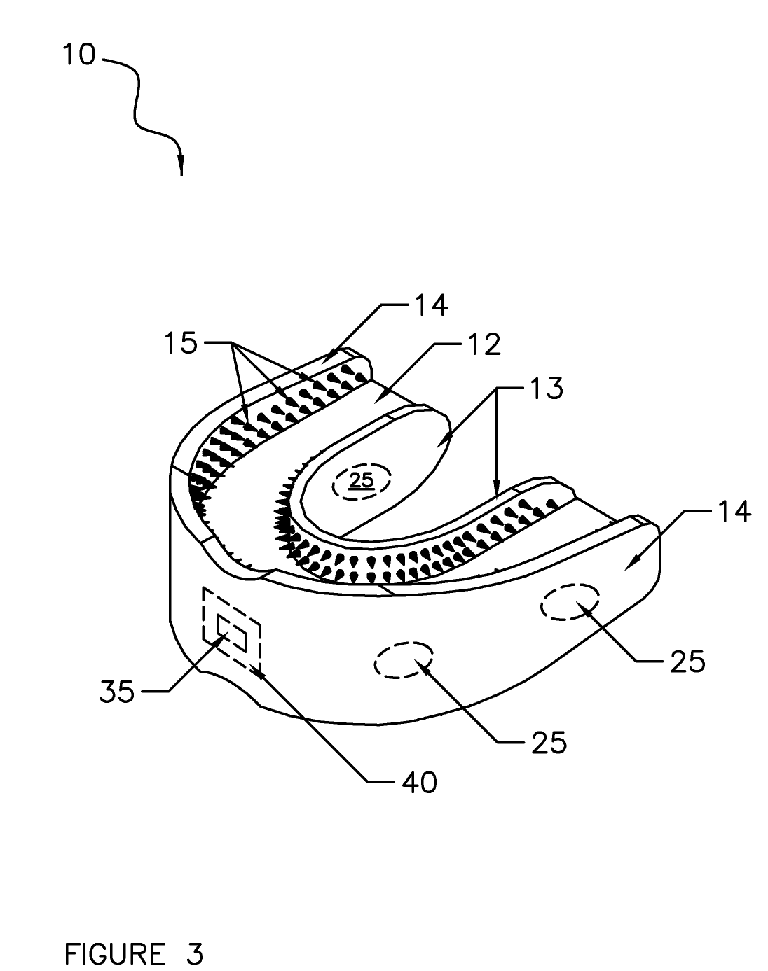

As shown in FIG. 3, the device 10 can include a switch 35 for regulating the operation of the vibration elements 25 via an integrated control unit 40. As described herein, the switch 35 can include any number of known devices capable of receiving a user input for control of the vibrating elements. Several examples include a traditional lightweight waterproof push button switch, and/or a waterproof tactile membrane switch, for example. In the preferred embodiment, a single switch will be utilized to control the operation of the vibration elements wherein repeatedly depressing the switch functions to first activate the units, then to subsequently increase the intensity of the vibrations caused by the units, then to deactivate the units (i.e., turn them off). Of course, this is but one possible avenue for controlling the device, and other embodiments which include multiple switches that each control the operation of a single vibration element, and/or multiple switches for controlling the operation of the plurality of vibration elements are also contemplated.

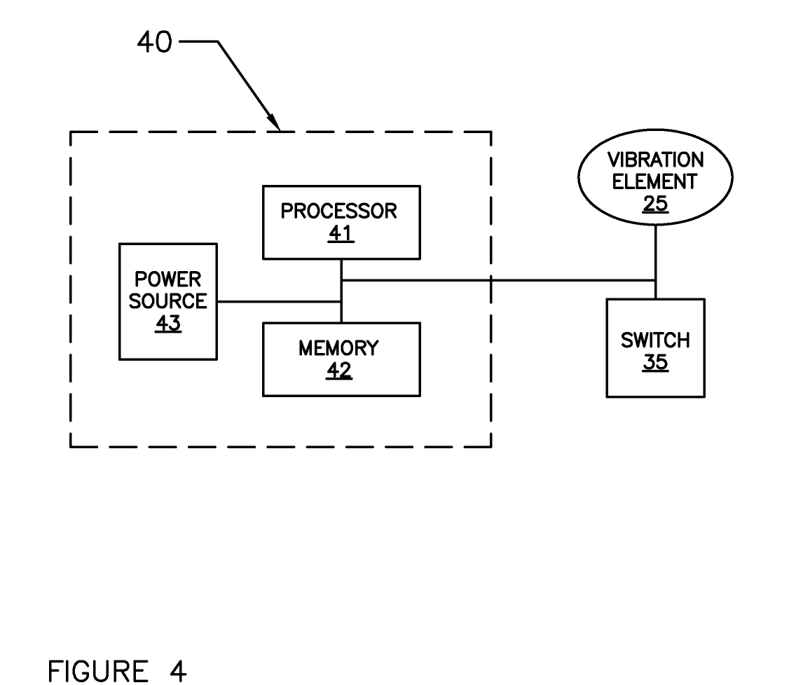

FIG. 4 illustrates a simplified block diagram of an exemplary control unit 40 of the device 10. As shown, the control unit can include a processor 41, a memory 42, and power source 43, that are conventionally linked together and to the switch 35 and the plurality of vibration elements 25.

The processor 41 can act to execute program code stored in the memory 42 in order to allow the device to perform the functionality described herein. Processors are extremely well known in the art, therefore no further description will be provided.

The memory 42 can act to store operating instructions in the form of program code for the processor 41 to execute. Although illustrated in FIG. 4 as a single component, memory 42 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 42 can also include one or more cache memories that provide temporary storage of at least some program code in order to reduce the number of times program code must be retrieved from the bulk storage device during execution. Each of these devices are well known in the art.

In one preferred embodiment, the memory 42 can include instructions for operating the plurality of vibration elements 25 at varying intensities and for a set period of time. To this end, the device 10 can provide a soothing massage wherein different portions of the user's gums are simultaneously receiving different vibration intensities in a controlled manner.

The power source 43 can include one or more DC batteries capable of providing the necessary power requirements to each element of the device 10. In one preferred embodiment, the power source can include lightweight rechargeable lithium-ion batteries which are securely positioned within the main body 11 along the bottom side thereof. Such positioning functions to facilitate charging of the batteries via a conventional wireless induction charger (not shown). Of course, other embodiments of the device that include a conventional receptacle for mating with a wire charger are also contemplated.

Although described above as separate individual elements, those of skill in the art will recognize that the control unit 40 can be manufactured in accordance with any number of known construction methodologies, and one or more of the above described elements can be joined onto a printed circuit board, for example, or other such manner suitable for performing the operation of the device as described throughout this document. Additionally, although described as including a processor and memory, other embodiments wherein the switch is directly connected to the power source 43 and the vibration units 25, thereby functioning as a simple on/off device are also contemplated. Such a feature thereby eliminating the need for the memory and processor.

Accordingly, the gum massaging mouthpiece 10 functions to fit within the mouth of a user and to position the plurality of resilient nubs in direct contact with the users gums. Upon activation of the vibration elements 25, the nubs vibrate against the gums thereby providing a soothing massage in an even and controlled manner.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A gum massaging mouthpiece, comprising:
a main body having a generally C-shaped base member that is in communication with a generally orthogonal inner wall and a generally orthogonal outer wall;
a plurality of vibrating elements disposed within the main body;
a plurality of nubs disposed along the main body; and
a switch that is electrically coupled to the plurality of vibrating elements.

2. The mouthpiece of claim 1, wherein the main body is constructed from a first material and the plurality of nubs are constructed from a second material.

3. The mouthpiece of claim 2, wherein the first material is configured to become ductile when a heat is applied thereto, and the second material is not configured to become ductile when heat is applied thereto.

4. The mouthpiece of claim 1, further comprising:
a control unit that is configured to control an operation of the vibration units and to receive instructions from the switch.

5. The mouthpiece of claim 4, wherein the control unit includes a processor, a memory, and a power source that are communicatively linked to each of the vibration units and the switch.

6. The mouthpiece of claim 5, wherein the memory further includes instructions for commanding the processor to activate the plurality of vibration units simultaneously at a different intensity level and for a predetermined period of time.

7. The mouthpiece of claim 5, wherein the power source includes at least one lightweight rechargeable DC battery configured to operate with a conventional induction battery charger.

8. The mouthpiece of claim 1, wherein the switch comprises a tactile membrane switch.

9. The mouthpiece of claim 1, wherein at least one vibrating unit is disposed within the base member.

10. The mouthpiece of claim 1, wherein at least one vibrating unit is disposed within the inner wall.

11. The mouthpiece of claim 1, wherein at least one vibrating unit is disposed within the outer wall.

12. The mouthpiece of claim 1, wherein at least one vibrating unit is disposed within each of the outer wall and the inner wall.

13. The mouthpiece of claim 1, wherein at least one vibrating unit is disposed within each of the inner wall, the outer wall and the base member.

14. The mouthpiece of claim 1, wherein each of the nubs include an identical shape and are disposed along the entirety of an inside facing portion of each of the inner and outer walls.

15. The mouthpiece of claim z, wherein the shape comprises a frustoconical shape.

16. The mouthpiece of claim 1, wherein at least one of the nubs includes a shape that is different than another of the nubs.

17. The mouthpiece of claim 1, wherein at least one of the nubs is disposed along the base member.
